(19) United States
(12) Patent Application Publication
(10) Pub. No.: US 2014/0357375 A1
(43) Pub. Date: Dec. 4, 2014

(54) MODIFYING ONLINE GAME FUNCTIONALITY BASED ON MOBILE USER ACQUISITION

(71) Applicants: Sudhir Kumar Rama Rao, San Jose, CA (US); David Quigley, San Francisco, CA (US)

(72) Inventors: Sudhir Kumar Rama Rao, San Jose, CA (US); David Quigley, San Francisco, CA (US)

(21) Appl. No.: 14/292,346

(22) Filed: May 30, 2014

Related U.S. Application Data
(60) Provisional application No. 61/829,450, filed on May 31, 2013.

(51) Int. Cl. A63F 13/30

(52) U.S. Cl. CPC A63F 13/12
USPC 463/42

(57) ABSTRACT

A method is disclosed for modifying a dynamic of an online game for a user based on characteristics of an advertising campaign that led to an acquiring of the user into the online game of a game networking system. An acquisition of a user into the online game is identified. A characteristic of an advertising campaign that led to the acquisition of the user into the online game is identified. A dynamic of the online game is modified based on the characteristic of the advertising campaign. In various embodiments, the modifying of the dynamic includes modifying initial characteristics of the online game.

### RELATED APPLICATION

The present application claims the benefit of priority to U.S. Provisional Patent Application Ser. No. 61/829,450, filed May 31, 2013, which is incorporated herein by reference in its entirety.

### FIELD

The present disclosure generally relates to online gaming, and more specifically, to methods and systems for managing a computer-implemented online game.

### BACKGROUND

An operator of a game networking system may use one or more advertising campaigns to seek to acquire new players to play one or more online games on the game networking system.

### BRIEF DESCRIPTION OF THE DRAWINGS

The example embodiments are illustrated by way of example, and not limitation, in the figures of the accompanying drawings, in which like reference numerals indicate the same or similar elements unless otherwise indicated.

FIG. 1 shows a schematic diagram of a virtual gaming system, according to some example embodiments, in which content is provided in a scrollable user interface.

FIG. 2 shows a block diagram of a feedback system, according to some example embodiments, for acquiring mobile users into an online game.

FIG. 3 shows a method, according to some example embodiments, for acquiring mobile users into an online game.

FIG. 4 shows a method, according to some example embodiments, for changing game dynamics based on user acquisition.

FIG. 5 shows a social network within a social graph, according to some example embodiments.

FIG. 6 illustrates data flow between example components of the example system of FIG. 1.

FIG. 7 illustrates an example network environment in which various embodiments may operate.

FIG. 8 illustrates example computing system architecture, which may be used to implement one or more of the methodologies described herein.

### DESCRIPTION OF EXAMPLE EMBODIMENTS

### Overview

Systems and methods of mobile user acquisition are described. In some example embodiments, the systems and methods generate and/or maintain a map of identifiers, such as a map that includes entries relating a new or existing mobile user (e.g., a user or player of an online game that accesses the online game via a mobile platform, such as via a mobile device) to a game identifier, a campaign identifier, and a user identifier. The systems and methods may utilize the related identifiers to provide feedback and/or perform actions associated with the acquisition of mobile users into the online game, among other things.

In some example embodiments, a game server may adjust and/or modify the game dynamics, such as interactions with a player (e.g., a new user) based on how the user was acquired, such as based on characteristics of a campaign via which a user entered and/or installed an online game.

These and other examples are described, by way of example, in further detail below.

### Example System

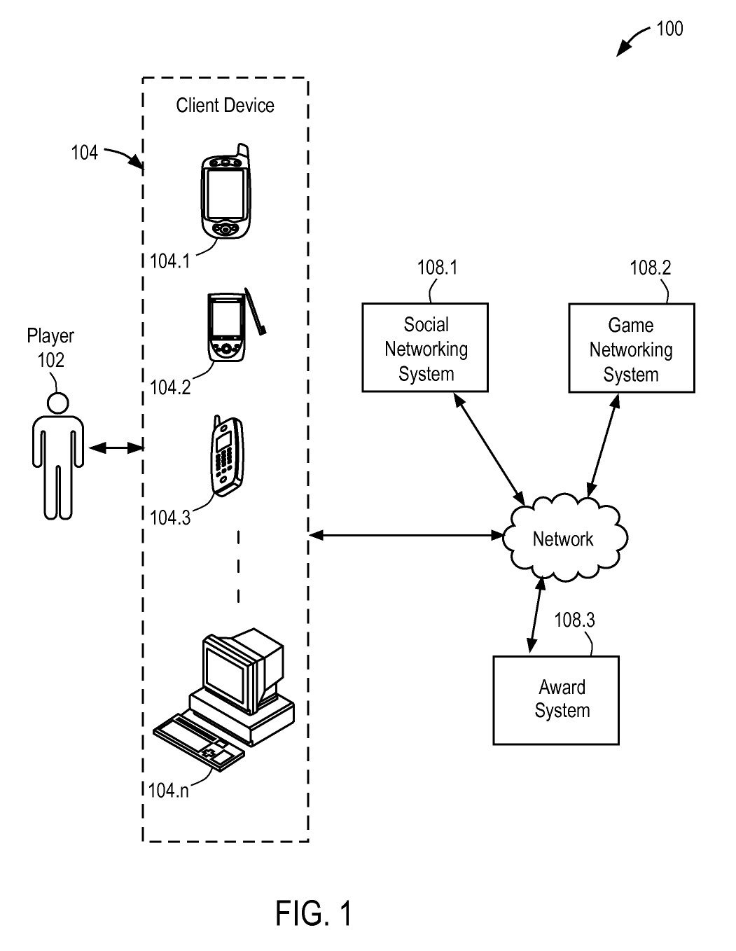

FIG. 1 shows a schematic diagram of a virtual gaming system 100, in accordance with an example embodiment, in which content is provided in a scrollable user interface. The system 100 may comprise a user device 104, a network 106, a social networking system 108.1, a game networking system 108.2, and an award system 108.3. The example components of the system 100 may be connected directly or via the network 106, which may be any suitable network. In various example embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, any other type of network, or a combination of two or more such networks.

Although FIG. 1 illustrates a particular example of the arrangement of the player 102, the user device 104, the social networking system 108.1, the game networking system 108.2, the award system 108.3, and the network 106, this disclosure includes any suitable arrangement or configuration of the player 102, the user device 104, the social networking system 108.1, the game networking system 108.2, the reward system 108.3, and the network 106.

The user device 104 may be any suitable computing device (e.g., devices 104.1-104.n), such as a smart phone 104.1, a personal digital assistant 104.2, a mobile phone 104.3, a personal computer 104.n, a laptop, a computing tablet, or any other device suitable for playing a virtual game. The user device 104 may access the social networking system 108.1 or the game networking system 108.2 directly, via the network 106, or via a third-party system. For example, the user device 104 may access the game networking system 108.2 via the social networking system 108.1. It should be noted that the functionality described herein may reside partially or wholly on any one device or be distributed across several devices.

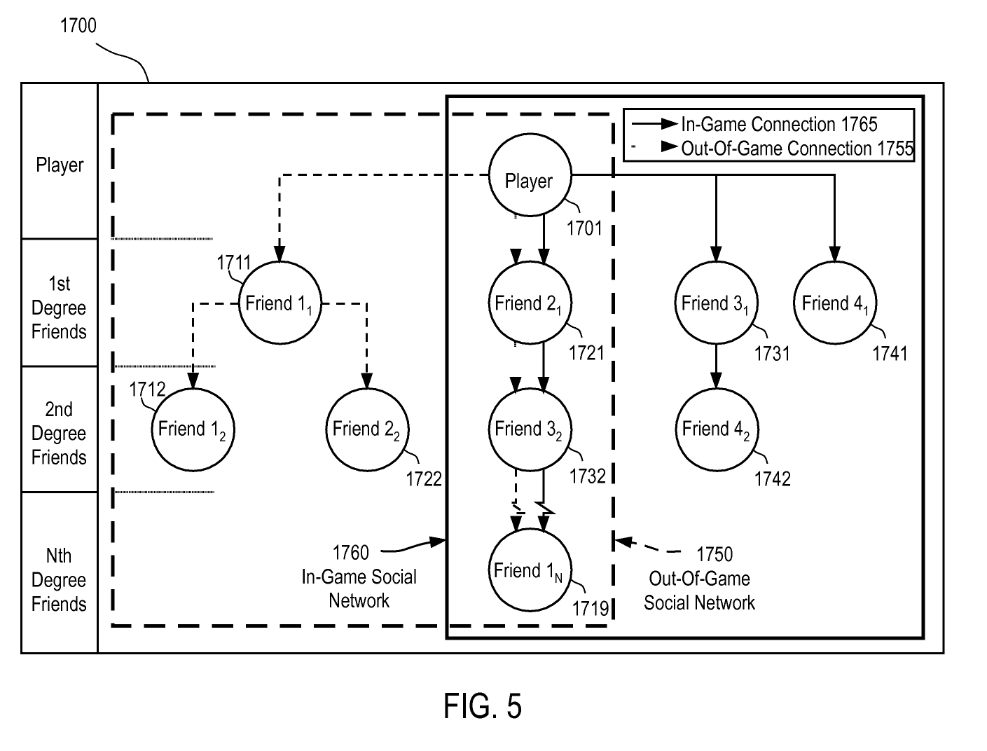

The social networking system 108.1 may include a network-addressable computing system that can host one or more social graphs (see, for example, FIG. 5), and may be accessed by the other components of the system 100 either directly or via the network 106. The social networking system 108.1 may generate, store, receive, and transmit social networking data.

### Example Mobile User Acquisition

Systems and methods of mobile user acquisition are described. In some example embodiments, the systems and methods generate and/or maintain a map of identifiers, such as a map that includes entries relating a new or existing mobile user (e.g., a user or player of an online game that accesses the online game via a mobile platform, such as via a mobile device) to a game identifier, a campaign identifier, and a user or device identifier. The systems and methods may utilize the related identifiers to provide feedback and/or perform actions associated with the acquisition of mobile users into the online game, among other things.

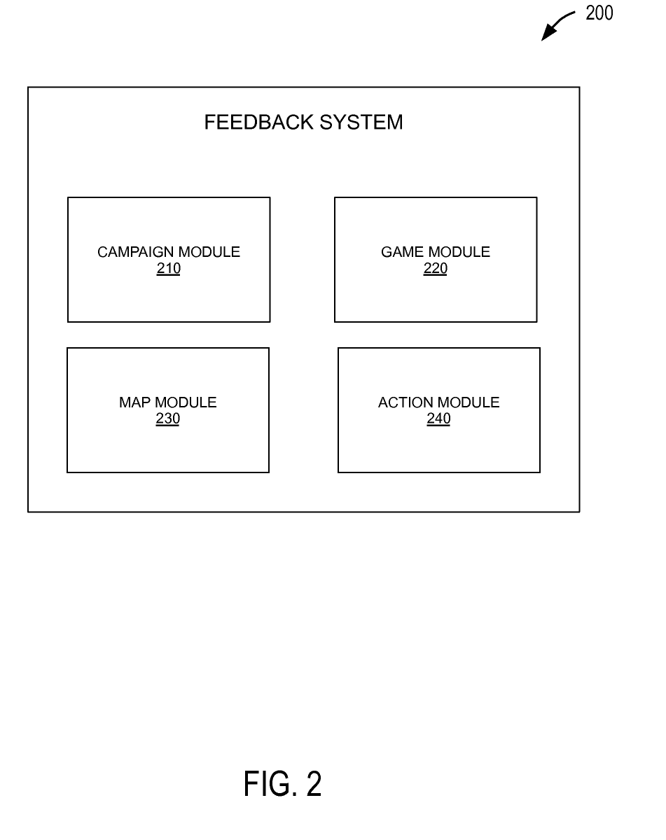

FIG. 2 shows a block diagram of a feedback system 200, according to some example embodiments, for acquiring mobile users into an online game.

As illustrated in FIG. 2, the feedback system 200 includes a variety of functional modules. One skilled in the art will appreciate that the functional modules are implemented with a combination of software (e.g., executable instructions, or computer code) and hardware (e.g., at least a memory and processor). Accordingly, as used herein, in some embodiments a module is a processor-implemented module and represents a computing device having a processor that is at least temporarily configured and/or programmed by executable instructions stored in memory to perform one or more of the particular functions that are described herein. Referring back to FIG. 2, the feedback system 200 includes a campaign module 210, a game module 220, a map module 230, and an action module 240.

In some example embodiments, the campaign module 210 is configured and/or programmed to capture an identifier or other information associated with a campaign (e.g., an advertisement, feed item, and so on) via which an online game acquired a mobile user. The campaign module 210 may communicate with, access, and/or receive information (e.g., via one or more APIs) from a click server associated with the campaign, and obtain an identifier for a campaign as well as a device identifier associated with a mobile device for the acquired user. For example, in response to a user selecting an advertisement and entering an online game, the campaign module 210 logs various information associated with the user selection, such as a URL for the campaign (e.g., a campaign ID), a device ID, a publisher ID, a geographic location of the event, a time of the event, and so on.

In some example embodiments, the game module 220 is configured and/or programmed to capture an identifier or other information associated with a game in which the user entered a game platform. For example, the game module 220 may determine the user clicked on advertisement for a certain game, and log a game ID for the game, as well as other information associated with the game, such as a publisher ID, initial game play characteristics, and so on. Additionally, the game module 220 may track and/or log a game install event of the game to the mobile device of the user, such as an install in response to the user selection of the campaign advertisement.

In some example embodiments, the map module 230 is configured and/or programmed to generate, update, and/or modify a map or other data structure that includes entries relating the various captured and/or collected identifiers for some or all of the acquired mobile users. For example, the map may store entries that relate, for an individual mobile user, the campaign ID, the device ID, the game ID, and/or a global game ID across all games provided by a game publisher.

In some example embodiments, the action module 240 is configured and/or programmed to perform actions based on the information contained in the map, such as provide feedback, modify advertisements or campaigns, and so on. For example, the action module 240 may determine, based on the map, that a user was acquired via a certain campaign (e.g., a campaign that provides new users with a certain amount of virtual currency), and present similar campaigns to the user to play and/or install other games, among other things.

Thus, in some example embodiments, the feedback system 200 enables a game platform, such as the game networking system 108.2, to recognize and/or track a player across various different games provided by the platform, and perform actions for the player that are based on knowledge of how the player was acquired, among other things.

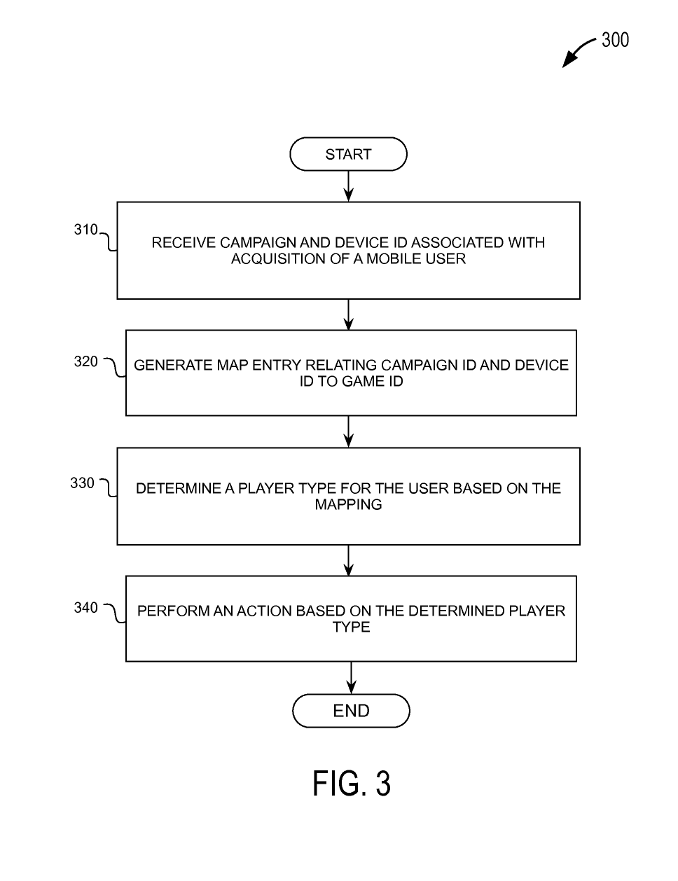

FIG. 3 shows a method, according to some example embodiments, for acquiring mobile users into an online game. In operation 310, the feedback system 200 receives and/or access a campaign ID and device ID associated with an acquisition of a player into an online game.

In operation 320, the feedback system 200 generates a map relating the campaign ID and the device ID to a game ID for the online game. For example, in one embodiment, the map may include a table having columns for game ID, campaign ID, and device ID. A first row of such a table may include “game12” in the game ID column, “www.campaignAB.com” in the campaign ID column, and “Device233” in the device ID column. A second row of the table may include “game13” in the game ID column, “www.campaignCDC.com” in the campaign ID column, and “Device234” in the Device ID column. A third row of the table may include “game123” in the device ID column, “www.advertA.com” in the campaign ID column, and “Device234” in the device ID column. Thus, the map may specify relationships between game identifiers, campaign identifiers, and device identifiers. In addition to the information shown in the table, the feedback system 200 may also provide a global player ID for users that play multiple games on a game platform, and relate the global player ID to the various game IDs associated with the games played by the users. Thus, the feedback system 200, in some example embodiments, may include an initial table that relates a global player ID to a device ID for the player, as well as other tables, such as a table that relates the player ID to multiple game IDs, a table that relates the device ID to the campaign ID (or, campaign IDs), and so on.

In operation 330, the feedback system 200 determines a player type for the user based on the mapping. The feedback system 330 may determine a player is a certain type of player based on identifying, via the map, the type of campaign used to acquire the player. For example, a player that enters an online game via an advertisement in his/her social network feed may be considered a “social player,” whereas a player that entered the online game via a game advertisement within another game already being played by the player may be considered a “repeat player,” among other things.

In operation 340, the feedback system 200 performs an action based on the determined type of the player. For example, the feedback system 200 may present similar advertisement campaigns to the player, may present similar advertisement campaigns to friends of the player, may award or reward the player with virtual currency or items, and so on.

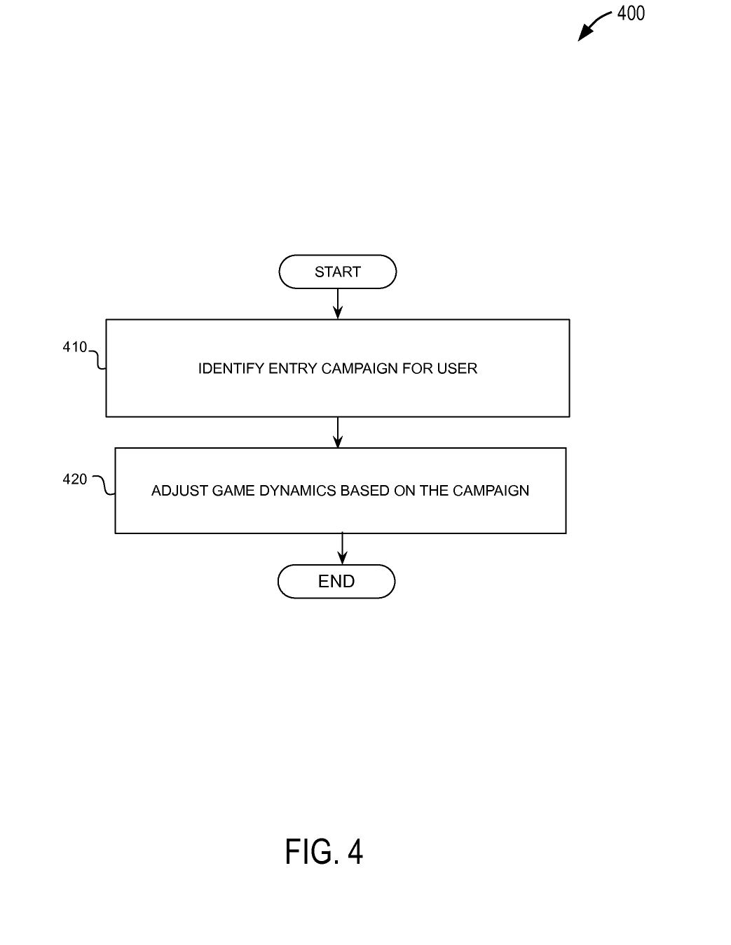

As described herein, in some example embodiments, a game server may adjust and/or modify the game dynamics, such as interactions with a player (e.g., a new user) based on how the user was acquired. FIG. 4 shows a method 400, according to some example embodiments, for changing game dynamics based on user acquisition.

In operation 410, the game server queries the map or database to identify an entry campaign for a user. For example, in response to receiving an indication that a player has installed or otherwise access an online game, the game server may query, in real-time or near real-time, one or more of the tables described herein, in order to identify the campaign via which the player entered the online game.

In operation 420, the game server adjusts and/or modifies game dynamics based on information associated with the campaign. For example the game server may adjust various game dynamics, such as dynamics associated with providing a user with initial gifts and/or reward, such as virtual currency, virtual items, incentives, and so on.

The game server, therefore, may target rewards, add rewards, modify rewards, lower or raise rewards, and so on, based on characteristics associated with the campaign via which the user entered and/or installed the online game.

For example, a game may have a mechanic in which it provides a newly acquired player with an initial reward (e.g., as an incentive for joining the game). Based on a detection by the game server that a particular advertising campaign led to the acquisition of the new player, the game server may adjust the initial reward that is to be provided to the new player. For example, based on a characteristic of the advertising campaign being that a new player is to be awarded with an additional reward (e.g., as an additional incentive for playing the game), the game server may modify the initial reward that would've been provided to the player if the advertising campaign had not led to the acquisition of the player.

In various embodiments, a game server includes a game having a mechanic in which a user is to be provided with an initial reward when the user joins the game as a new player. While playing a different game, the player is presented with an advertising campaign that advertises an additional incentive for the player to play the game. For example, a characteristic of the advertising campaign may be that users who join the game as new players are to be provided with an additional reward. Based on a determination that the advertising campaign led to the acquisition of the user as a new player of the game, the game server modified the initial reward by, for example, increasing or decreasing a value of the reward. The modification of the reward may be based on an analysis of the characteristic of the advertising campaign (e.g., a value of the additional reward that is to be provided). Based on a determination that the advertising campaign led to the acquisition of the new player, the game server may add an entry to a map that specifies relationships between games, users, and advertising campaigns, for example. In various embodiments, the game server may use this map to, for example, determine additional advertising campaigns to present to the player (e.g., to incentivize the player to join further games) or determine how to modify the initial reward.

It is contemplated that the embodiments described herein may be extended to any game mechanic, such as the harvest mechanic discussed above. For example, based on a characteristic of an advertising campaign, a player may be presented with rewards for harvesting crops that are different from rewards for harvesting crops that are offered to players who are not acquired through the advertising campaign. In various embodiments, various timings associating with the harvesting mechanic may be adjusted (e.g., the time between which crops must be harvested before they day may increase or decrease). As another example, the game server may modify player character states or attributes based on characteristics associated with the advertising campaign. For example, player characters of new players may be provided with different equipment, powers, etc., based on whether an advertising campaign led to the acquisition of the new player.

### Example Game Systems, Social Networks, and Social Graphs

FIG. 5 shows an example of a social network within a social graph 1700. In example embodiments, a virtual landscape or environment of a player may be visible to other players of the virtual game.

The social graph 1700 is shown by way of example to include an out-of-game social network 1750 and an in-game social network 1760. Moreover, the in-game social network 1760 may include one or more players that are friends with the User 1701 (e.g., a Friend 1731), and may include one or more other users that are not friends with the User 1701. The social graph 1700 may correspond to the various users associated with the virtual game. In an example embodiment, each user may “build” their own virtual structures using branded virtual objects and/or unbranded virtual objects.

As described above, the example systems described herein may include, communicate, or otherwise interact with a game system. As such, a game system is now described to illustrate further example embodiments. In an online multiuser game, users control player characters (PCs), a game engine controls non-player characters (NPCs); the game engine also manages player character state and tracks states for currently active (e.g., online) users and currently inactive (e.g., offline) users. A game engine, in some embodiments, may include a documentation engine. Alternatively, the documentation engine and game engine may be embodied as separate components operated by the game network system and/or the document provision system.

A player character may have a set of attributes and a set of friends associated with the player character. As used herein, the terms “state” and “attribute” can be used interchangeably to refer to any in-game characteristic of a player character, such as location, assets (e.g., value icons), levels, condition, health, status, inventory, skill set, name, orientation, affiliation, specialty, and so on. The game engine may use a player character state to determine the outcome of a game event, while sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights, and/or benefits or the obtaining of some assets (e.g., health, money (e.g., virtual currency from a value icon), strength, inventory, land, etc.). A game engine may determine the outcome of a game event according to game rules (e.g., “a character with less than 5 health points will be prevented from initiating an attack”), based on a character's state, and also possibly on interactions of other player characters and a random calculation. Moreover, an engagement may include simple tasks (e.g., cross the river, shoot at an opponent, interact with a value icon, or the like), complex tasks (e.g., win a battle, unlock a puzzle, build a factory, rob a liquor store), or other events.

In a game system according to some aspects of the present disclosure, in determining the outcome of a game event in a game being played by a user (or a group of more than one users), the game engine may take into account the state of the player character (or group of PCs) that is playing, but also the state of one or more PCs of offline/inactive users who are connected to the current user (or PC, or group of PCs) through the game social graph but are not necessarily involved in the game at the time.

For example, a User A with six friends on User A's team (e.g., the friends that are listed, depending on the nature of the game, as being in the user's mob/gang/set/army/business/crew/etc.) may be playing the virtual game and choose to confront a User B who has 20 friends on User B's team. In some embodiments, a user may only have first-degree friends on the user's team. In other embodiments, a user may also have second-degree and higher degree friends on the user's team. To resolve the game event, in some embodiments, the game engine may total up the weapon strength of the seven members of the User A's team and the weapon strength of the 21 members of the User B's team and decide an outcome of the confrontation based on a random variable applied to a probability distribution that favors the side with the greater total. In some embodiments, all of this may be done without any other current active participants other than the User A (e.g., the User A's friends, the User B, and the User B's friends could all be offline or inactive). In some embodiments, the friends in a user's team may see a change in their state as part of the outcome of the game event. In some embodiments, the state (assets, condition, level) of friends beyond the first degree are taken into account.

A virtual game may be hosted by the game networking system 108.2, which can be accessed using any suitable connection 110 with a suitable user device 104. A user may have a game account on the game networking system 108.2, wherein the game account may contain a variety of information associated with the user (e.g., the user's personal information, financial information, purchase history (e.g., of in-game assets), player character state, game state, or any other user profile data). In some embodiments, a user may play multiple games on the game networking system 108.2, which may maintain a single game account for the user with respect to the multiple games, or multiple individual game accounts for each game with respect to the user. In an example embodiment, virtual currency awarded by a scratch card may be used across multiple games. In some embodiments, the game networking system 108.2 may assign a unique identifier to a player 102 of a virtual game hosted on the game networking system 108.2. The game networking system 108.2 may determine that the player 102 is accessing the virtual game by reading the user's cookies, which may be appended to HTTP requests transmitted by the user device 104, and/or by the player 102 logging onto the virtual game.

In some embodiments, the player 102 accesses a virtual game and controls the game's progress via the user device 104 (e.g., by inputting commands to the game at the user device 104). The user device 104 can display the game interface, receive inputs from the player 102, transmit user inputs or other events to the game engine, and receive instructions from the game engine. The game engine can be executed on any suitable system (such as, for example, the user device 104, the social networking system 108.1, or the game networking system 108.2). For example, the user device 104 may download client components of a virtual game, which are executed locally, while a remote game server, such as the game networking system 108.2, provides backend support for the client components and may be responsible for maintaining application data of the game, processing the inputs from the player 102, updating and/or synchronizing the game state based on the game logic and each input from the player 102, and transmitting instructions to the user device 104. As another example, when the player 102 provides an input to the game through the user device 104 (such as, for example, by typing on the keyboard, clicking the mouse, or interacting with a touch screen of the user device 104), the client components of the game may transmit the user's input to the game networking system 108.2.

In some embodiments, the player 102 accesses particular game instances of a virtual game. A game instance is a copy of a specific game play area that is created during runtime. In some embodiments, a game instance is a discrete game play area where one or more players 102 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables.

In some embodiments, a specific game instance may be associated with one or more specific users. A game instance is associated with a specific user when one or more game parameters of the game instance are associated with the specific user. For example, a game instance associated with a first user may be named “First User's Play Area.” This game instance may be populated with the first user's PC and one or more in-game objects associated with the first user.

In some embodiments, a game instance associated with a specific user is only accessible by that specific user. For example, a first user may access a first game instance when playing a virtual game, and this first game instance may be inaccessible to all other users. In other embodiments, a game instance associated with a specific user is accessible by one or more other users, either synchronously or asynchronously with the specific user's game play. For example, a first user may be associated with a first game instance, but the first game instance may be accessed by all first-degree friends in the first user's social network.

In some embodiments, the set of in-game actions available to a specific user is different in a game instance that is associated with this user compared to a game instance that is not associated with this user. The set of in-game actions available to a specific user in a game instance associated with this user may be a subset, superset, or independent of the set of in-game actions available to this user in a game instance that is not associated with him. For example, a first user may be associated with Blackacre Farm in an online farming game and may be able to plant crops on Blackacre Farm. If the first user accesses a game instance associated with another user, such as Whiteacre Farm, the game engine may not allow the first user to plant crops in that game instance. However, other in-game actions may be available to the first user, such as watering or fertilizing crops on Whiteacre Farm. Likewise, a value icons may have restrictions.

In some embodiments, a game engine interfaces with a social graph (e.g., to obtain user profile data from the social graph to, inter alia, configure the virtual scratch cards). Social graphs are models of connections between entities (e.g., individuals, users, contacts, friends, users, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a user or player character in an online multiuser game.

In some embodiments, the social graph is managed by the game networking system 108.2, which is managed by the game operator. In other embodiments, the social graph is part of a social networking system 108.1 managed by a third party (e.g., Facebook, Friendster, Myspace). In yet other embodiments, the player 102 has a social network on both the game networking system 108.2 and the social networking system 108.1, wherein the player 102 can have a social network on the game networking system 108.2 that is a subset, superset, or independent of the user's social network on the social networking system 108.1. In such combined systems, game network system 108.2 can maintain social graph information with edge-type attributes that indicate whether a given friend is an “in-game friend,” an “out-of-game friend,” or both. The various embodiments disclosed herein are operable when the social graph is managed by the social networking system 108.1, the game networking system 108.2, or both.

Returning to FIG. 5, the User 1701 may be associated, connected, or linked to various other users, or “friends,” within the out-of-game social network 1750. These associations, connections, or links can track relationships between users within the out-of-game social network 1750 and are commonly referred to as online “friends” or “friendships” between users. Each friend or friendship in a particular user's social network within a social graph is commonly referred to as a “node.” For purposes of illustration, the details of out-of-game social network 1750 are described in relation to User 1701. As used herein, the terms “user” and “player” can be used interchangeably and can refer to any user in an online multiuser game system or social networking system. As used herein, the term “friend” can mean any node within a user's social network.

As shown in FIG. 5, User 1701 has direct connections with several friends. When the User 1701 has a direct connection with another individual, that connection is referred to as a first-degree friend. In out-of-game social network 1750, the User 1701 has two first-degree friends. That is, the User 1701 is directly connected to Friend 1₁ 1711 and Friend 2₁ 1721. In social graph 1700, it is possible for individuals to be connected to other individuals through their first-degree friends (e.g., friends of friends). As described above, the number of edges in a minimum path that connects a user to another user is considered the degree of separation. For example, FIG. 5 shows that User 1701 has three second-degree friends to which User 1701 is connected via User 1701's connection to User 1701's first-degree friends. Second-degree Friend 1₂ 1712 and Friend 2₂ 1722 are connected to User via User 1701's first-degree Friend 1₁ 1711. The limit on the depth of friend connections, or the number of degrees of separation for associations, that User 1701 is allowed is typically dictated by the restrictions and policies implemented by the social networking system 108.1.

In various embodiments, User 1701 can have Nth-degree friends connected to him through a chain of intermediary degree friends as indicated in FIG. 5. For example, Nth-degree Friend 1_{N} 1719 is connected to User 1701 within in-game social network 1760 via second-degree Friend 3₂ 1732 and one or more other higher-degree friends.

In some embodiments, a user (or player/player character) has a social graph within an online multiuser game that is maintained by the game engine and another social graph maintained by a separate social networking system. FIG. 5 depicts an example of in-game social network 1760 and out-of-game social network 1750. In this example, User 1701 has out-of-game connections 1755 to a plurality of friends, forming out-of-game social network 1750. Here, Friend 1₁ 1711 and Friend 2₁ 1721 are first-degree friends with User 1701 in User 1701's out-of-game social network 1750. User 1701 also has in-game connections 1765 to a plurality of users, forming in-game social network 1760. Here, Friend 2₁ 1721, Friend 17₁ 1731, and Friend 4₁ 1741 are first-degree friends with User 1701 in User 1701's in-game social network 1760. In some embodiments, a game engine can access in-game social network 1760, out-of-game social network 1750, or both.

In some embodiments, the connections in a user's in-game social network are formed both explicitly (e.g., when users “friend” each other) and implicitly (e.g., when the system observes user behaviors and “friends” users to each other). Unless otherwise indicated, reference to a friend connection between two or more users can be interpreted to cover both explicit and implicit connections, using one or more social graphs and other factors to infer friend connections. The friend connections can be unidirectional or bidirectional. It is also not a limitation of this description that two users who are deemed “friends” for the purposes of this disclosure are not friends in real life (e.g., in disintermediated interactions or the like), but that could be the case.

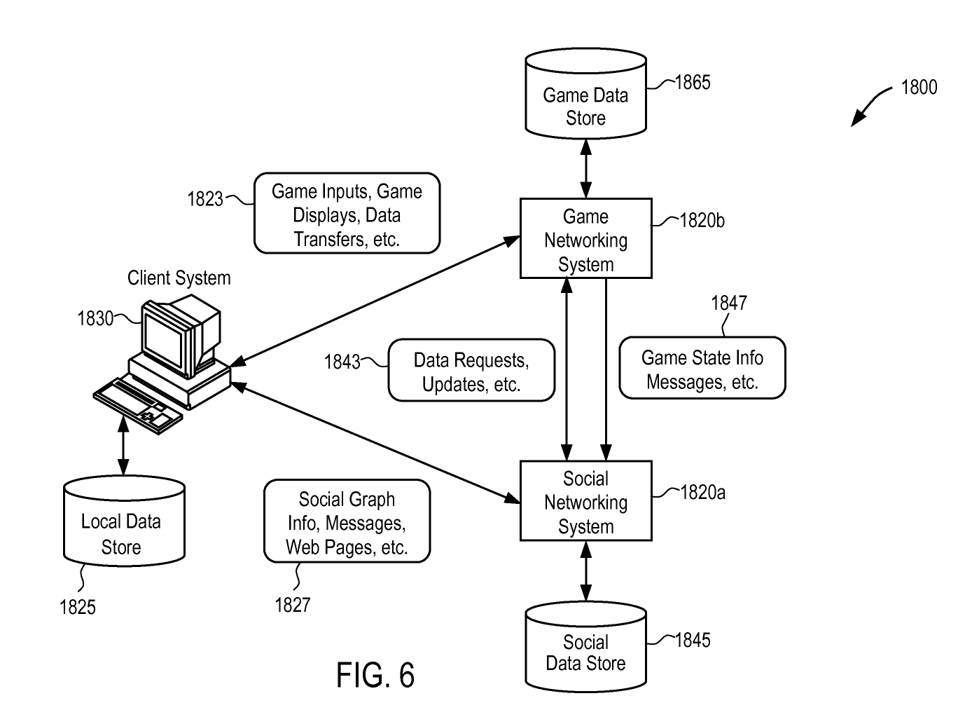

FIG. 6 shows an example data flow between example components of an example system 1800. One or more of the components of the example system 1800 may correspond to one or more of the components of the example system 100. In some embodiments, system 1800 includes a client system 1830, a social networking system 1820a, and a game networking system 1820b. The components of system 1800 can be connected to each other in any suitable configuration, using any suitable type of connection. The components may be connected directly or over any suitable network. The client system 1830, the social networking system 1820a, and the game networking system 1820b may have one or more corresponding data stores, such as the local data store 1825, the social data store 1845, and the game data store 1865, respectively.

The client system 1830 may receive and transmit data 1823 to and from the game networking system 1820b. This data can include, for example, a web page, a message, a game input, a game display, a HTTP packet, a data request, transaction information, and other suitable data. At some other time, or at the same time, the game networking system 1820b may communicate data 1843, 1847 (e.g., game state information, game system account information, page info, messages, data requests, updates, etc.) with other networking systems, such as the social networking system 1820a (e.g., Facebook, Myspace, etc.). The client system 1830 can also receive and transmit data 1827 to and from the social networking system 1820a. This data can include, for example, web pages, messages, social graph information, social network displays, HTTP packets, data requests, transaction information, updates, and other suitable data.

Communication between the client system 1830, the social networking system 1820a, and the game networking system 1820b can occur over any appropriate electronic communication medium or network using any suitable communication protocol. For example, the client system 1830, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a user accesses a virtual game on the game networking system 1820b, the BLOB containing the game state for the instance corresponding to the user may be transmitted to the client system 1830 for use by a client-side executed object to process. In some embodiments, the client-side executable is a FLASH-based game, which can de-serialize the game state data in the BLOB. As a user plays the game, the game logic implemented at the client system 1830 maintains and modifies the various game state parameters locally. The client-side game logic may also batch game events, such as mouse clicks, and transmit these events to the game networking system 1820b. Game networking system 1820b may itself operate by retrieving a copy of the BLOB from a database or an intermediate memory cache (memcache) layer. The game networking system 1820b can also de-serialize the BLOB to resolve the game state parameters and execute its own game logic based on the events in the batch file of events transmitted by the client to synchronize the game state on the server side. The game networking system 1820b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a user selects one or more actions to perform. The web pages may be displayed in a browser client executed on the client system 1830. For example, a client application downloaded to the client system 1830 may operate to serve a set of web pages to a user. As another example, a virtual game may be an animated or rendered game executable as a stand-alone application or within the context of a webpage or other structured document. In some embodiments, the virtual game is implemented using Adobe Flash-based technologies. As an example, a game may be fully or partially implemented as a SWF object that is embedded in a web page and executable by a Flash media user plug-in. In some embodiments, one or more described web pages are associated with or accessed by the social networking system 1820a. This disclosure contemplates using any suitable application for the retrieval and rendering of structured documents hosted by any suitable network-addressable resource or website.

Application event data of a game is any data relevant to the game (e.g., user inputs or interations). In some embodiments, each application datum may have a name and a value, and the value of the application datum may change (e.g., be updated) at any time. When an update to an application datum occurs at the client system 1830, either caused by an action of a game user or by the game logic itself, the client system 1830 may need to inform the game networking system 1820b of the update. For example, if the game is a farming game with a harvest mechanic (such as FarmVille by Zynga), an event can correspond to a user clicking on a parcel of land to harvest a crop. In such an instance, the application event data may identify an event or action and an object in the game to which the event or action applies.

In some embodiments, one or more objects of a game are represented as an Adobe Flash object. Flash may manipulate vector and raster graphics, and supports bidirectional streaming of audio and video. “Flash” may mean the authoring environment, the user, or the application files. In some embodiments, the client system 1830 may include a Flash client. The Flash client may be configured to receive and run a Flash application or game object code from any suitable networking system (such as, for example, the social networking system 1820a or the game networking system 1820b). In some embodiments, the Flash client is run in a browser client executed on the client system 1830. A user can interact with Flash objects using the client system 1830 and the Flash client. The Flash objects can represent a variety of in-game objects. Thus, the user may perform various in-game actions on various in-game objects by making various changes and updates to the associated Flash objects.

In some embodiments, in-game actions are initiated by clicking or similarly interacting with a Flash object that represents a particular in-game object. For example, a user can interact with a Flash object to use, move, rotate, delete, scratch, attack, shoot, redeem virtual currency from a value object, or harvest an in-game object. This disclosure contemplates performing any suitable in-game action by interacting with any suitable Flash object. In some embodiments, when the user makes a change to a Flash object representing an in-game object, the client-executed game logic may update one or more game state parameters associated with the in-game object. To ensure synchronization between the Flash object shown to the user at the client system 1830, the Flash client may send the events that caused the game state changes to the in-game object to the game networking system 1820b. However, to expedite the processing and, hence, the speed of the overall gaming experience, the Flash client may collect a batch of some number of events or updates into a batch file. The number of events or updates may be determined by the Flash client dynamically or determined by the game networking system 1820b based on server loads or other factors. For example, client system 1830 may send a batch file to the game networking system 1820b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to user data or metadata, changes to user social connections or contacts, user inputs to the game, and events generated by the game logic. The user profile data may include application event data. In some embodiments, each application datum has a name and a value. The value of an application datum may change at any time in response to the game play of a user or in response to the game engine (e.g., based on the game logic). In some embodiments, an application data update occurs when the value of a specific application datum is changed.

In some embodiments, when a user plays a virtual game on the client system 1830, the game networking system 1820b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular user and a particular virtual game. In some embodiments, while a user is not playing the virtual game, the corresponding BLOB may be stored in the database. This enables a user to stop playing the game at any time without losing the current state of the game the user is in. When a user resumes playing the game next time, game networking system 1820b may retrieve the corresponding BLOB from the database to determine the most-recent values of the game-related data. In some embodiments, while a user is playing the virtual game, the game networking system 1820b also loads the corresponding BLOB into a memory cache so that the game system may have faster access to the BLOB and the game-related data contained therein.

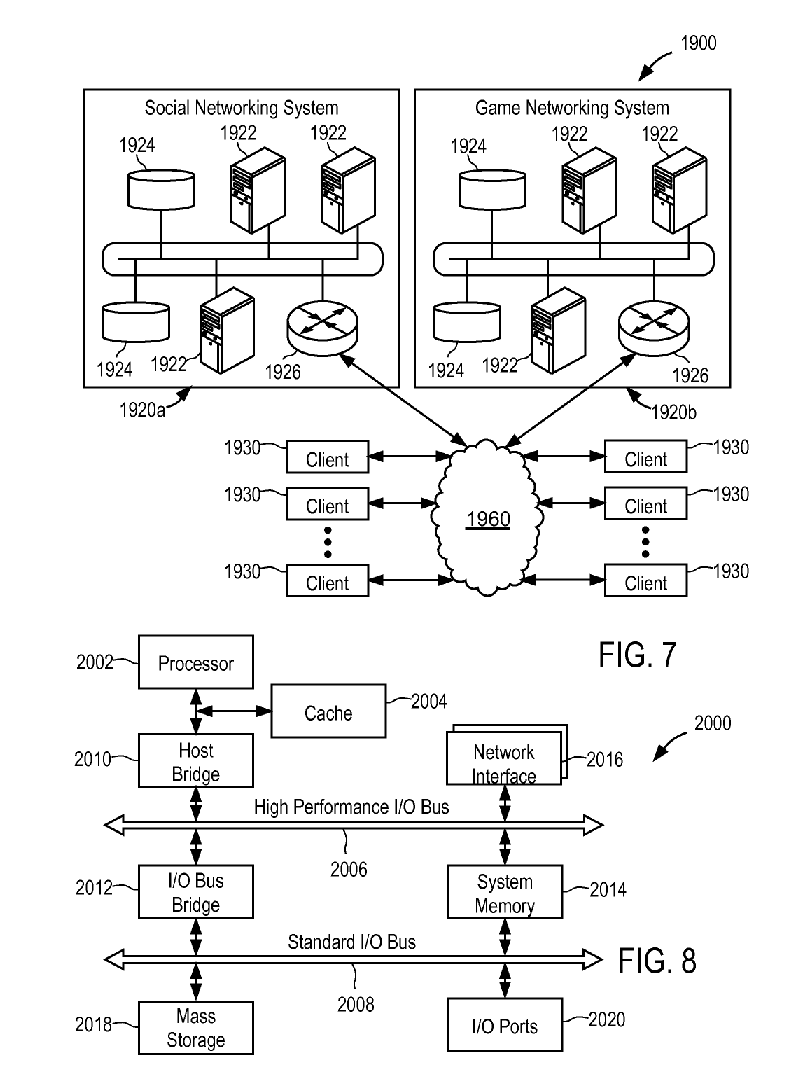

Various embodiments may operate in a WAN environment, such as the Internet, including multiple network addressable systems. FIG. 7 shows an example network environment 1900, in which various example embodiments may operate. A network cloud 1960 generally represents one or more interconnected networks, over which the systems and hosts described herein can communicate. Network cloud 1960 may include packet-based WANs (such as the Internet), private networks, wireless networks, satellite networks, cellular networks, paging networks, and the like. As FIG. 7 illustrates, various embodiments may operate in a network environment 1900 comprising one or more networking systems, such as a social networking system 1920a, a game networking system 1920b, a reward system 1920c, and one or more client systems 1930. The components of the social networking system 1920a, the game networking system 1920b, and reward system 1920c operate analogously; as such, hereinafter they may be referred to simply as the networking system 1920. The client systems 1930 are operably connected to the network cloud 1960 via a network service provider, a wireless carrier, or any other suitable means.

The networking system 1920 is a network addressable system that, in various example embodiments, comprises one or more physical servers 1922 and data stores 1924. The one or more physical servers 1922 are operably connected to computer network cloud 1960 via, by way of example, a set of routers and/or networking switches 1926. In an example embodiment, the functionality hosted by the one or more physical servers 1922 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), Flash, ActionScript, and the like.

The physical servers 1922 may host functionality directed to the operations of the networking system 1920. Hereinafter servers 1922 may be referred to as server 1922, although the server 1922 may include numerous servers hosting, for example, the networking system 1920, as well as other content distribution servers, data stores, and databases. Data store 1924 may store content and data relating to, and enabling operation of, the networking system 1920 as digital data objects. A data object, in some embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like.

Logically, data store 1924 corresponds to one or more of a variety of separate and integrated databases, such as relational databases and object-oriented databases, that maintain information as an integrated collection of logically related records or files stored on one or more physical systems. Structurally, data store 1924 may generally include one or more of a large class of data storage and management systems. In some embodiments, data store 1924 may be implemented by any suitable physical system(s) including components, such as one or more database servers, mass storage media, media library systems, storage area networks, data storage clouds, and the like. In one example embodiment, data store 1924 includes one or more servers, databases (e.g., MySQL), and/or data warehouses. Data store 1924 may include data associated with different networking system 1920 users and/or client systems 1930.

The client system 1930 is generally a computer or computing device including functionality for communicating (e.g., remotely) over a computer network. The client system 1930 may be a desktop computer, laptop computer, tablet computer, in- or out-of-car navigation system, smart phone or other cellular or mobile phone, or mobile gaming device, among other suitable computing devices. Client system 1930 may execute one or more client applications, such as a Web browser.

When a user at a client system 1930 desires to view a particular webpage (hereinafter also referred to as target structured document) hosted by the networking system 1920, the user's web browser, or other document rendering engine or suitable client application, formulates and transmits a request to the networking system 1920. The request generally includes a URL or other document identifier as well as metadata or other information. By way of example, the request may include information identifying the user, a timestamp identifying when the request was transmitted, and/or location information identifying a geographic location of the user's client system 1930 or a logical network location of the user's client system 1930.

Although the example network environment 1900 described above and illustrated in FIG. 7 is described with respect to the social networking system 1920a and the game networking system 1920b, this disclosure encompasses any suitable network environment using any suitable systems. For example, a network environment may include online media systems, online reviewing systems, online search engines, online advertising systems, or any combination of two or more such systems.

FIG. 8 illustrates an example computing system architecture, which may be used to implement a server 1922 or a client system 1930. In one embodiment, the hardware system 2000 comprises a processor 2002, a cache memory 2004, and one or more executable modules and drivers, stored on a tangible computer-readable storage medium, directed to the functions described herein. Additionally, the hardware system 2000 may include a high performance input/output (I/O) bus 2006 and a standard I/O bus 2008. A host bridge 2010 may couple the processor 2002 to the high performance I/O bus 2006, whereas the I/O bus bridge 2012 couples the two buses 2006 and 2008 to each other. A system memory 2014 and one or more network/communication interfaces 2016 may couple to the bus 2006. The hardware system 2000 may further include video memory (not shown) and a display device coupled to the video memory. Mass storage 2018 and I/O ports 2020 may couple to the bus 2008. The hardware system 2000 may optionally include a keyboard, a pointing device, and a display device (not shown) coupled to the bus 2008. Collectively, these elements are intended to represent a broad category of computer hardware systems.

The elements of the hardware system 2000 are described in greater detail below. In particular, the network interface 2016 provides communication between the hardware system 2000 and any of a wide range of networks, such as an Ethernet (e.g., IEEE 802.3) network, a backplane, or the like. The mass storage 2018 provides permanent storage for the data and programming instructions to perform the above-described functions implemented in servers 1922 of FIG. 7, whereas system memory 2014 (e.g., DRAM) provides temporary storage for the data and programming instructions when executed by the processor 2002. I/O ports 2020 are one or more serial and/or parallel communication ports that provide communication between additional peripheral devices, which may be coupled to the hardware system 2000.

The hardware system 2000 may include a variety of system architectures, and various components of the hardware system 2000 may be rearranged. For example, cache memory 2004 may be on-chip with the processor 2002. Alternatively, the cache memory 2004 and the processor 2002 may be packed together as a “processor module,” with processor 2002 being referred to as the “processor core.” Furthermore, certain embodiments of the present disclosure may neither require nor include all of the above components. For example, the peripheral devices shown coupled to the standard I/O bus 2008 may couple to the high performance I/O bus 2006. In addition, in some embodiments, only a single bus may exist, with the components of the hardware system 2000 being coupled to the single bus. Furthermore, the hardware system 2000 may include additional components, such as additional processors, storage devices, or memories.

An operating system manages and controls the operation of the hardware system 2000, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a,” “an,” or “the” is intended to mean “one or more” unless specifically indicated to the contrary. In addition, it is to be understood that functional operations, such as “awarding,” “locating,” “permitting,” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments, the term “web service” and “website” may be used interchangeably and, additionally, may refer to a custom or generalized API on a device, such as a mobile device (e.g., cellular phone, smart phone, personal GPS, personal digital assistance (PDA), personal gaming device, etc.), that makes API calls directly to a server. Still further, while the embodiments described above operate with business-related virtual objects (such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A method comprising:
identifying a player acquisition in which a user becomes a new player of a computer-implemented online game;
identifying a characteristic of an advertising campaign that led to the acquisition of the user; and
modifying a dynamic of the online game based on the characteristic of the advertising campaign, the modifying of the dynamic of the online game being performed by a computer processor.

2. The method of claim 1, further comprising:
identifying an additional player acquisition in which an additional user becomes an additional new player of the computer-implemented game;
identifying that the advertising campaign did not lead to the acquisition of the user; and
based on the identifying that the advertising campaign did not lead to the acquisition of the user, leaving the dynamic of the online game unmodified.

3. The method of claim 1, wherein the characteristic pertains to a reward that is to be provided to the user and the modifying of the dynamic of the online game includes one of increasing an initial reward associated with the online game and decreasing the initial reward associated with the online game.

4. The method of claim 1, the characteristic pertains to a reward that is to be provided to the user and the modifying of the dynamic of the online game includes providing the user with an additional reward.

5. The method of claim 1, wherein the characteristic pertains to virtual currency that is to be provided to the user and the modifying of the dynamic of the online game includes one of increasing an initial virtual currency associated with the game and decreasing the initial virtual currency associated with the game.

6. The method of claim 1, wherein the identifying of the acquisition of the user into the online game is based on the user installing the game on a mobile device via the advertising campaign.

7. The method of claim 1, wherein the identifying of the acquisition of the user entering the online game via the advertising campaign.

8. A system comprising:
one or more modules implemented by one or more computer processors, the one or more modules configured to:
identify a player acquisition in which a user becomes a new player of a computer-implemented online game;
identify a characteristic of an advertising campaign that led to the acquisition of the user; and
modify a dynamic of the online game based on the characteristic of the advertising campaign.

9. The system of claim 8, wherein the characteristic pertains to a reward that is to be provided to the user and the modifying of the dynamic of the online game includes one of increasing an initial reward associated with the online game and decreasing the initial reward associated with the online game.

10. The system of claim 8, wherein the characteristic pertains to a reward that is to be provided to the user and the modifying of the dynamic of the online game includes providing the user with an additional reward.

11. The system of claim 8, wherein the characteristic pertains to virtual currency that is to be provided to the user and the modifying of the dynamic of the online game includes one of increasing an initial virtual currency associated with the game and decreasing the initial virtual currency associated with the game.

12. The system of claim 8, wherein the identifying of the acquisition of the user into the online game is based on the user installing the game on a mobile device via the advertising campaign.

13. The method of claim 8, wherein the identifying of the acquisition of the user entering the online game via the advertising campaign.

14. The system of claim 9, wherein the initial reward is one of a plurality of initial game play characteristics that are modified based on the characteristic of the advertising campaign during the modifying of the dynamic of the online game.

15. A non-transitory machine-readable medium comprising instructions that, identifying a player acquisition in which a user becomes a new player of a computer-implemented online game;
identifying a characteristic of an advertising campaign that led to the acquisition of the user; and
modifying a dynamic of the online game based on the characteristic of the advertising campaign.

16. The non-transitory machine-readable medium of claim 15, wherein the characteristic pertains to a reward that is to be provided to the user and the modifying of the dynamic of the online game includes one of increasing an initial reward associated with the online game and decreasing the initial reward associated with the online game.

17. The non-transitory machine-readable medium of claim 15, the characteristic pertains to a reward that is to be provided to the user and the modifying of the dynamic of the online game includes providing the user with an additional reward.

18. The non-transitory machine-readable medium of claim 15, wherein the characteristic pertains to virtual currency that is to be provided to the user and the modifying of the dynamic of the online game includes one of increasing an initial virtual currency associated with the game and decreasing the initial virtual currency associated with the game.

19. The non-transitory machine-readable medium of claim 15, wherein the identifying of the acquisition of the user into the online game is based on the user installing the game on a mobile device via the advertising campaign.

20. The non-transitory machine-readable medium of claim 15, wherein the identifying of the acquisition of the user entering the online game via the advertising campaign.
